(19) United States
(12) Patent Application Publication
(10) Pub. No.: US 2006/0107843 A1
(43) Pub. Date: May 25, 2006

(54) Confectionery dispenser

(75) Inventor: Ulrik Skovgaard Rasmussen, Middelfart (DK)

Correspondence Address: CANTOR COLBURN, LLP, 55 GRIFFIN ROAD SOUTH, BLOOMFIELD, CT, 06002, US

(73) Assignee: Dandy A/S, Vejle (DK)

(21) Appl. No.: 10/530,534

(22) PCT Filed: Oct. 7, 2003
(86) PCT No.: PCT/DK03/00665

§ 371 Date: Sep. 21, 2005

(30) Foreign Application Priority Data
Oct. 7, 2002 (NL) EP 02079198.4

(51) Int. Cl. A23P 1/00

(52) U.S. Cl. 99/450.1

(57) ABSTRACT

The invention relates to a confectionery dispenser (100) comprising at least two confectionery article (11) magazines (12), each said confectionery article magazine (12) comprising a magazine outlet being coupled with at least one confectionery article dispenser outlet (13), preferably one, by means of at least one magazine discharge arrangement said magazine discharge arrangement comprising at least one confectionery article fitting compartment (19, 20, 21) adapted for performing a movement relative to said magazine outlets upon activation of an activation arrangement (101) and thereby a transferring at least one confectionery article (11) comprised in at least one confectionery article magazine (12) to said magazine outlet (13) or to at least one output compartment (A, B, C). According to the invention, an advantageous magazine fed vendor machine has been obtained.

### FIELD OF THE INVENTION

The invention relates to a confectionery article dispenser according to claim 1 and a method of storing confectionery articles according to claim 10.

### BACKGROUND OF THE INVENTION

Several types of confectionery dispensers, also referred to as vendoring machines within the art, have been provided over the last hundred years.

One problem of the existing confectionery dispensers is that the dispensers are restricted to deal with articles having certain shapes or certain volume characterizing sizes. Typically, such vendor machines require a certain degree of disorder in order to obtain a reliable output.

It is an object of the invention to provide a confectionery dispenser, which may sustain typical environmental influence, such as weather and vandalism, and which may handle edgy articles in a reliable and user-friendly way.

### SUMMARY OF THE INVENTION

The invention relates to a confectionery dispenser comprising at least two confectionery article magazines,

each said confectionery article magazine comprising a magazine outlet being coupled with at least one confectionery article dispenser outlet, preferably one, by means of at least one magazine discharge arrangement

said magazine discharge arrangement comprising at least one confectionery article fitting compartment adapted for performing a movement relative to said magazine outlets upon activation of an activation arrangement and thereby transferring at least one confectionery article comprised in at least one confectionery article magazine to said magazine outlet or to at least one output compartment.

According to the invention, an advantageous magazine fed vendor machine has been obtained.

In an embodiment of the invention, said confectionery article magazines being exchangeable.

According to a preferred embodiment of the invention, the dispenser may simply be refilled by exchange of emptied or partly emptied magazines by means of pre-filled magazines.

It should be noted that the relative movement may of course be obtained by the movement of the magazines, the articles fitting compartments alone or both in combination.

In an embodiment of the invention, said output compartment being mechanically coupled with said at least one outlet and thereby facilitating a transfer of at least one confectionery article upon activation of said activation arrangement.

In an embodiment of the invention, said activation arrangement is manually driven.

In an embodiment of the invention, said activation arrangement is automatically driven.

In an embodiment of the invention, said article comprising chewing gum packages.

In an embodiment of the invention, said magazine discharge arrangement comprising at least one confectionery article fitting compartment being rotatable upon activation by said activation arrangement.

In an embodiment of the invention, said magazines being fitted to the dispenser in a substantially vertical direction thereby obtaining a gravity facilitated emptying of the magazines into the lower compartments when activating the magazine discharge arrangement.

In an embodiment of the invention, said magazines being fitted in a substantially circular profile, when seen from above.

In an embodiment of the invention, the magazines define the orientation of the magazine contained article.

In an embodiment of the invention, the magazines are substantially translucent, thereby facilitating that a user of the dispenser may visually see at least some of the magazine contained articles, preferably most of the articles.

In an embodiment of the invention, the magazines are arranged within a substantially translucent housing.

Moreover, the invention relates to a method of storing confectionery articles, preferably chewing gum packages, in a confectionery dispenser, said dispenser comprising at least one user activation arrangement communicating with at least one confectionery discharge arrangement, said at least one confectionery discharge arrangement adapted for discharge of confectionery articles into an outlet under user control by means of said user activation arrangement and whereby said confectionery articles being fed to said discharge arrangement by means of at least two confectionery article holding magazines.

According to a preferred embodiment of the invention, the orientation of the articles stored in the dispenser may be controlled, simply by adapting the shape of the article to the magazines or vice versa.

According to the invention, the articles should fit into the magazines and thereby ensure that the packaging is orientated completely in the desired way, thereby facilitating that the design of the article packages may be presented in a predetermined way.

In this way, the dispenser may in fact be adapted for use with several different types of packages, as the design of the packaging may in fact be the only product describing means.

Preferably, a package should be comprised in a magazine with for example the front side oriented outwardly during the complete discharging of the magazine. It should however be noted that magazine design may in fact predetermine a varying orientation during the magazine discharging.

In an embodiment of the invention, the magazines define the orientation of the magazine contained articles.

In an embodiment of the invention, the stored articles are visible or at least substantially viable to a user of the dispenser.

### THE DRAWINGS

The invention will now be disclosed with reference to the drawings, of which

FIG. 1a to 1c illustrate the principles of discharging a magazine fed-dispenser according to a preferred embodiment of the invention,

FIG. 2 illustrates main components of a dispenser according to a preferred embodiment of the invention in perspective, and where

FIG. 3 illustrates a dispenser according to the invention in a perspective view.

### DETAILED DESCRIPTION

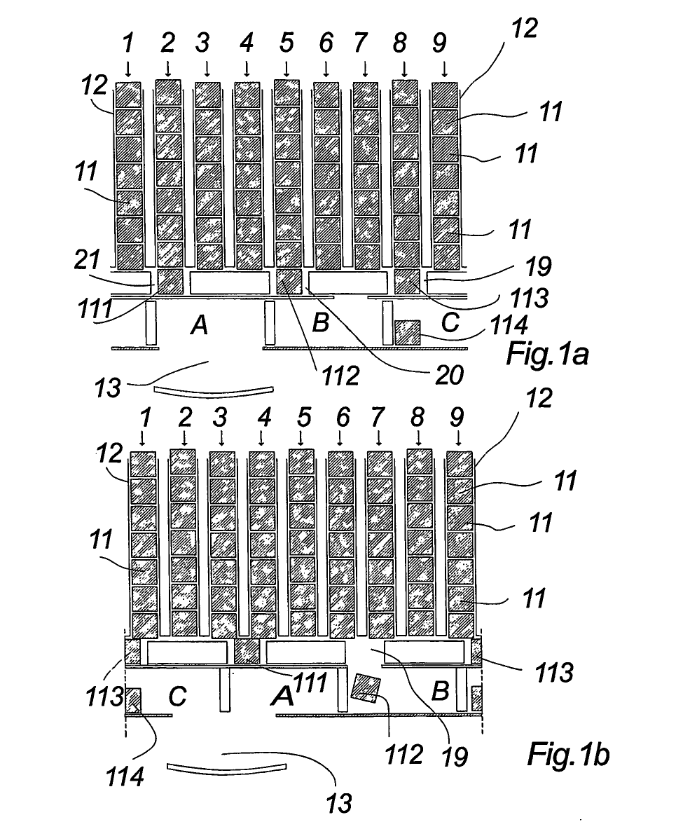

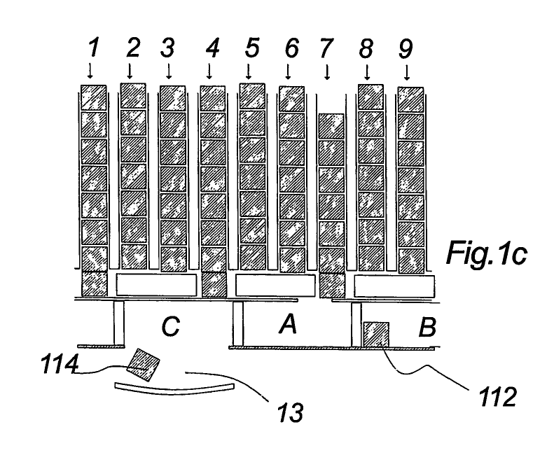

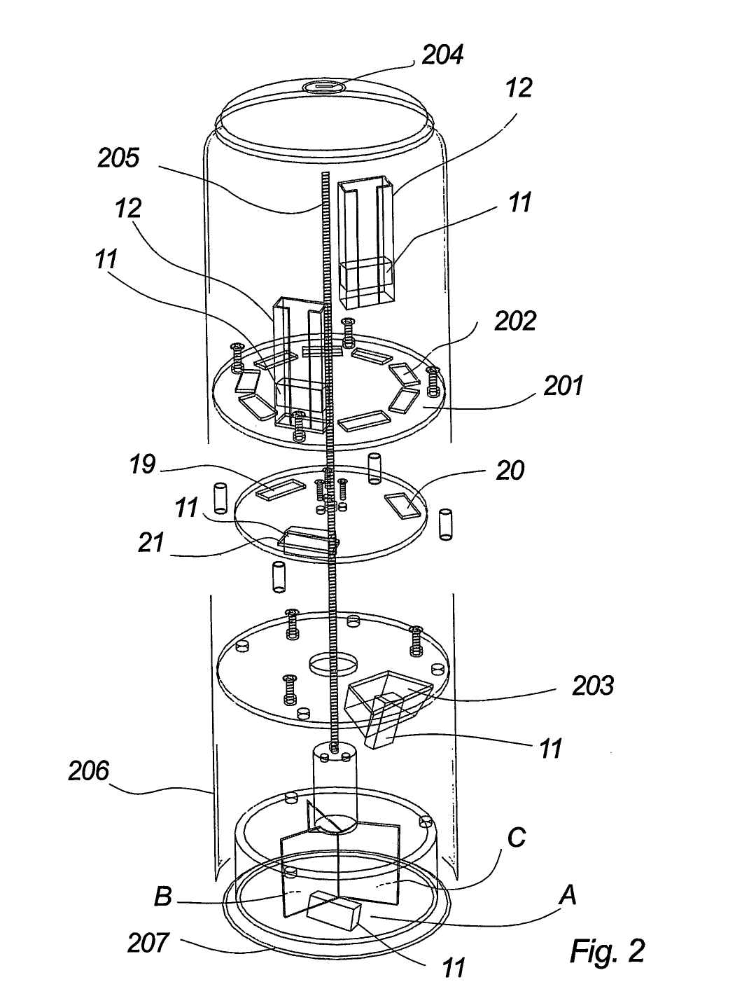

FIG. 1a-to 1c and FIG. 2 illustrate a preferred embodiment of a confectionery dispenser according to the invention. Preferably, the relevant confectionery comprises chewing gum packages 11.

The illustrated dispenser comprises nine magazines 12. The magazines 12 contain chewing gum package rows 1,2,3,4,5,6,7,8 and 9. According to the illustrated embodiment, each magazine 12 contains seven packages as from the beginning. It should be noted that almost any other number of packages may be applied within the scope of the invention.

The shown flat-view cross-sections illustrate the cross-section of the magazines 12, when the magazines are arranged upside-down and in a circle in a typical vendor machine. The real three-dimensional arrangement of the magazine is illustrated in FIG. 2.

The magazines 12 communicate with a magazine discharge arrangement comprising three compartments 19, 20, 21 adapted for transferring of a confectionery article from a magazine to an intermediate compartment A, B or C.

According to the invention, practically any number from 1 and above of the compartments 19, 20, 21 may be applied within the scope of the invention.

Moreover, practically any number from 1 and above of the intermediate compartments A, B and C may be applied within the scope of the invention.

The function of the three compartments 19, 20, and 21 may be illustrated in FIG. 1a to 1c. The three compartments 19, 20, 21 initially contain three confectionery packages 111, 112, 113. According to a preferred embodiment of the invention, the dispenser should preferably dispense exactly one confectionery article 11 each time the dispenser is activated by a user. Evidently, practically any other number may be applied within the scope of the invention. If the number is two, the three compartments of the present embodiment should be able to hold two articles 11 instead of the one illustrated, 111, 112, 113.

Moreover, the above-mentioned intermediate compartment C contains a confectionery article 114 and the compartments A and B are empty.

When an (not shown) activation arrangement is activated, manually or automatically by a user, the compartments 19, 20, 21 and the intermediate compartments A, B and C are rotated.

The rotating movement of the two layers of compartments 19, 20, 21; A, B, C results in that the package 114 is rotated from left to right. As illustrated in FIG. 1b, the initial result of this movement is that the article 112 contained in the compartment 19 is transferred from compartments 19 to the intermediate compartments B under influence by the rotating compartments and gravity. At the same time the article 114 is also rotated from left to right.

It should be noted that the magazines may be rotated in any suitable way according to the invention, including right to left.

In FIG. 1c, the article 114 is released from the compartment C to the outlet 13 and moreover, again under influence of gravity, the row of articles 7, pushes a new confectionery article into the compartment 19, and the dispenser is now ready for a new dispensing operation.

It should be emphasised that the discharge of packages 11 may for example be performed under influence of discharge means, such as springs or other suitable discharge resulting means.

It should be noted according to the illustrated preferred embodiment of the invention that the magazines are emptied from left to right, that is the row of articles 7 is emptied at first, then row 8, row 9, row 1, etc. until the last row 6.

According to the invention, this kind of controlled emptying is strongly preferred, partly due to the fact that the initially emptied magazines 12 may be located at the least visible side of the dispenser. Moreover, and very important, the magazines are emptied one at a time, thereby making the refilling somewhat easier due to the fact that the partly emptied magazines will never exceed one. Thereby, refill may be performed preferably by means of full magazines.

According to a preferred embodiment the illustrated magazines may be exchanged completely by pre-filled magazines 12.

It should also be noted that the illustrated embodiment may preferably be utilized for dispensing of chewing gum packages.

It should also be noted that the invention is in particular advantageous in combination with edged articles due to the fact that the edged articles may be somewhat difficult to control when transferring the articles from a prior art container to the outlet of the dispenser.

Evidently, the dispenser may also even be utilized for dispensing of rounded articles.

Moreover, the invention facilitates a magazine-wise emptying which is quite important when dealing with, for instance, confectionery articles having a limited shelf life. In this way, it is possible to establish and keep track of the age of the articles.

Preferably, the illustrated dispenser may be activated by means of e.g. a coin-receiving interface, and preferable the dispenser is adapted for use at public places.

According to a preferred embodiment of the invention, the orientation of the articles 11 stored in the dispenser may be controlled, simply by adapting the shape of the article to the magazines or vice versa.

According to the invention, the articles should fit into the magazines and thereby ensure that the packaging is orientated completely in the desired way, thereby facilitating that the design of the article packages may be presented in a predetermined way.

In this way, the dispenser may in fact be adapted for use with several different types of packages, as the design of the packaging may in fact be the only product describing means.

Preferably, a package should be comprised in a magazine with for example the front side oriented outwardly during the complete discharging of the magazine. It should however be noted that magazine design may in fact predetermine a varying orientation during the magazine discharging.

FIG. 2 illustrates a corresponding three-dimensional view of the dispenser as illustrated in FIG. 1a to 1c. The illustrated dispenser comprises nine magazines 12 of which only two are illustrated on FIG. 2.

The magazines 12 are contained in dispenser housing comprising an upper part 206, preferably translucent, which may be locked to a foundation 207 by means of an upper lock 204, mechanically lockable to the foundation by means of a lock member 205.

Confectionery articles 11 may be contained in the magazines 12 and the magazines may be founded to a circular foundation 201 while fitting to corresponding down-stream openings 202.

A magazine discharge arrangement comprises article-holding compartments 19, 20, 21. An article 11 is illustrated when slipping into the compartment 21.

An opening 203 serves as a discharge arrangement output into the compartments A, B and C and finally the compartments communicate with an outlet (not shown).

For a full description of the feed-through mechanism, please refer to the above explanation of FIG. 1a to FIG. 1c.

It should be noted that one of the two rotatable compartment systems 19, 20, 21 and A, B, C may in fact be omitted while still obtaining an advantageous emptying of the magazines.

However, the illustrated two-step lock-like emptying system is preferred in order to counteract environmental impact on the articles, vandalism, etc.

According to the invention, a low-cost confectionery dispenser has been provided due to the fact that dispenser mechanism may be established by simple and inexpensive means.

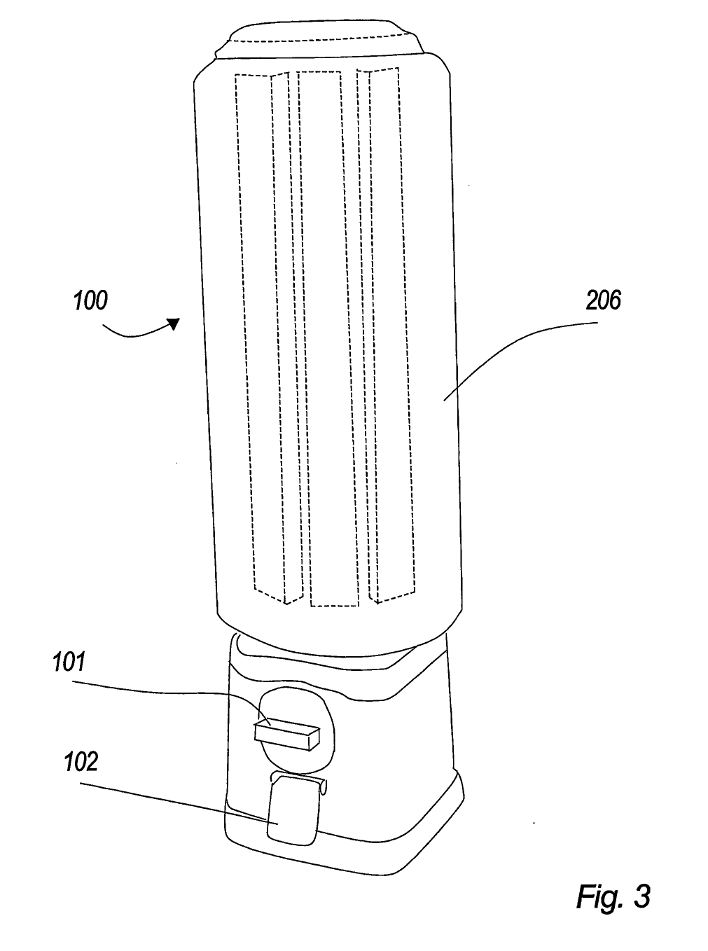

FIG. 3 illustrates the outer visible parts of a dispenser 100 comprising activation means 101 and an article outlet 102.

Preferably the upper part 206 of the dispenser 100 is translucent as mentioned in FIG. 2.

The dispenser comprises a user interface in the form of a rotatable grip 101, which may be manually activated while inserting payment (such as coins) and the resulting output may be retrieved at the outlet 102.

Preferably, the illustrated dispenser may be activated by means of e.g. a coin-receiving interface integrated in said grip 101, and preferable the dispenser is adapted for use at public places.

1.-15. (canceled)

16. Confectionery dispenser comprising:
at least two confectionery article magazines, each said at least two confectionery article magazines comprising a magazine outlet being coupled with at least one confectionery article dispenser outlet by means of at least one magazine discharge arrangement;
said magazine discharge arrangement comprising at least one confectionery article fitting compartment adapted for performing a movement relative to said magazine outlets upon activation of an activation arrangement and thereby transferring at least one confectionery article comprised in at least one confectionery article magazine to at least one output compartment; and
said at least one output compartment being adapted for performing a rotating movement upon activation of said activation arrangement and thereby transferring at least one confectionery article comprised in at least one of said output compartments to said dispenser outlet.

17. Confectionery dispenser according to claim 1, wherein said confectionery article magazines are exchangeable.

18. Confectionery dispenser according to claim 1, wherein said output compartment is mechanically coupled with said at least one outlet and thereby facilitating a transfer of at least one confectionery article upon activation of said activation arrangement.

19. Confectionery dispenser according to claim 1, wherein the activation arrangement is manually driven.

20. Confectionery dispenser according to claim 1, wherein the activation arrangement is automatically driven.

21. Confectionery dispenser according to claim 1, wherein said article comprises chewing gum packages.

22. Confectionery dispenser according to claim 1, wherein said magazine discharge arrangement comprises at least one confectionery article fitting compartment being rotatable upon activation by said activation arrangement.

23. Confectionery dispenser according to claim 1, wherein said magazines are fitted to the dispenser in a substantially vertical direction thereby obtaining a gravity facilitated emptying of the magazines into lower compartments when activating the magazine discharge arrangement.

24. Confectionery dispenser according to claim 1, wherein said magazines are fitted in a substantially circular profile, when seen from above.

25. Confectionery dispenser according to claim 1, wherein the magazines define an orientation of the magazine contained article.

26. Confectionery dispenser according to claim 1, wherein the magazines are substantially translucent, thereby facilitating that a user of the dispenser may visually see at least some of the magazine contained articles.

27. Confectionery dispenser according to claim 1, wherein the magazines are arranged within a substantially translucent housing.

28. Confectionery dispenser according to claim 1, wherein said confectionery articles are fed to said discharge arrangement by means of at least two confectionery article holding magazines.
